(19) United States
(12) Patent Application Publication
(10) Pub. No.: US 2022/0090504 A1
(43) Pub. Date: Mar. 24, 2022

(54) ROTOR BLADE FOR A GAS TURBINE ENGINE HAVING A METALLIC STRUCTURAL MEMBER AND A COMPOSITE FAIRING

(71) Applicant: General Electric Company, Schenectady, NY (US)

(72) Inventors: Matthew Mark Weaver, Loveland, OH (US); Kirk Douglas Gallier, Liberty Township, OH (US)

(21) Appl. No.: 17/030,595

(22) Filed: Sep. 24, 2020

(51) Int. Cl. F01D 5/18; F01D 5/30; F01D 25/00

(52) U.S. Cl. CPC F01D 5/187; F01D 25/00; F01D 5/30

(57) ABSTRACT

A rotor blade for a gas turbine engine includes a structural member formed from a metallic material. The structural member, in turn, includes a base portion, a spar, and a tip cap, with the base portion at least partially forming a root of the rotor blade and a shank of the rotor blade. Furthermore, the structural member includes a fairing formed from a composite material. The fairing is, in turn, coupled to the structural member such that the fairing forms at least a portion of an airfoil of the rotor blade and a platform of the rotor blade. Additionally, the fairing including a first fairing panel and a second fairing panel in contact with the first fairing panel at a first split line and a second split line.

### FIELD

The present disclosure generally pertains to rotor blades for gas turbine engines, and, more specifically, to a rotor blade for a gas turbine engine having a metallic structural member and a composite fairing.

### BACKGROUND

A gas turbine engine generally includes a compressor section, a combustion section, and a turbine section. During operation, the compressor section progressively increases the pressure of air entering the engine and supplies this compressed air to the combustion section. The compressed air and a fuel mix within the combustion section and burn within a combustion chamber to generate high-pressure and high-temperature combustion gases. The combustion gases flow through a hot gas path defined by the turbine section before exiting the engine. In this respect, the turbine section converts energy from the combustion gases into rotational energy. Specifically, the turbine section includes a plurality of rotor blades, which extract kinetic energy and/or thermal energy from the combustion gases flowing therethrough. The extracted rotational energy is, in turn, used to rotate one or more shafts, thereby driving the compressor section and/or a fan assembly of the gas turbine engine.

Traditionally, turbine rotor blades have been formed from metallic materials, such as nickel-based alloys. While well-suited for the mechanical loads placed on the rotor blades, such metallic materials limit the temperatures at which the engine can operate. As such, in recent years, the use of ceramic matrix composite (CMC) materials to form turbine rotor blades has grown dramatically. CMC materials are capable of withstanding higher temperatures than metallic materials, thereby increasing the operating temperature range of the engine. However, CMC materials are unable to withstand the same mechanical loads as metallic materials. In this respect, turbine rotor blades incorporating both metallic and CMC materials have been developed. While such turbine rotor blades work well, further improvement are needed.

Accordingly, an improved rotor blade for a gas turbine engine would be welcomed in the technology.

### BRIEF DESCRIPTION

Aspects and advantages of the invention will be set forth in part in the following description, or may be obvious from the description, or may be learned through practice of the invention.

In one aspect, the present subject matter is directed to a rotor blade for a gas turbine engine. The rotor blade includes a structural member formed from a metallic material. The structural member, in turn, includes a base portion, a spar, and a tip cap, with the base portion at least partially forming a root of the rotor blade and a shank of the rotor blade. Furthermore, the structural member includes a fairing formed from a composite material. The fairing is, in turn, coupled to the structural member such that the fairing forms at least a portion of an airfoil of the rotor blade and a platform of the rotor blade. Additionally, the fairing includes a first fairing panel and a second fairing panel in contact with the first fairing panel at a first split line and a second split line.

In another aspect, the present subject matter is directed to a gas turbine engine. The gas turbine engine includes a compressor section, a combustion section, a turbine section, and a rotor blade positioned within the turbine section. The rotor blade, in turn, includes a structural member formed from a metallic material. Moreover, the structural member including a base portion, a spar, and a tip cap, with the base portion at least partially forming a root of the rotor blade and a shank of the rotor blade. Additionally, the rotor blade includes a fairing formed from a composite material. The fairing is, in turn, coupled to the structural member such that the fairing forms at least a portion of an airfoil of the rotor blade and a platform of the rotor blade. Furthermore, the fairing includes a first fairing panel and a second fairing panel in contact with the first fairing panel at a first split line and a second split line.

In a further aspect, the present subject matter is directed to a rotor blade for a gas turbine engine. The rotor blade includes a structural member formed from a metallic material. The structural member, in turn, includes a base portion, a spar, and a tip cap, with the base portion at least partially forming a root of the rotor blade and a shank of the rotor blade. Furthermore, the structural member includes a fairing formed from a composite material. The fairing is, in turn, coupled to the structural member such that the fairing forms at least a portion of an airfoil of the rotor blade and a platform of the rotor blade. Additionally, the fairing includes a first fairing panel having a first projection and a second fairing panel having a second projection in contact with the first projection.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of one embodiment of a gas turbine engine;

FIG. 2 is a side view of one embodiment of a rotor blade for a gas turbine engine;

FIG. 3 is a side view of one embodiment of a structural member of a rotor blade for a gas turbine engine;

FIG. 4 is a cross-sectional view of one embodiment of an airfoil of a rotor blade for a gas turbine engine, particularly illustrating a plurality of cooling passages defined by the rotor blade;

FIG. 5 is an enlarged, partial cross-sectional view of another embodiment of an airfoil of a rotor blade for a gas turbine engine;

FIG. 6 is an enlarged, partial cross-sectional view of a further embodiment of an airfoil of a rotor blade for a gas turbine engine;

FIG. 7 is a partial rear view of one embodiment of an airfoil of a rotor blade for a gas turbine engine, particularly illustrating a plurality of cooling holes defined by the blade;

FIG. 8 is cross-sectional view of another embodiment of a structural member of a rotor blade for a gas turbine engine, particularly illustrating a spar of a structural member of the rotor blade defining a cooling passage; and

FIG. 9 is an enlarged, partial cross-sectional view of yet another embodiment of an airfoil of a rotor blade for a gas turbine engine.

Repeat use of reference characters in the present specification and drawings is intended to represent the same or analogous features or elements of the present invention.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope or spirit of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components.

Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

Additionally, the terms “low,” “high,” or their respective comparative degrees (e.g., lower, higher, where applicable) each refer to relative speeds within an engine, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section.

In general, the present subject matter is directed to a rotor blade for a gas turbine engine. As will be described below, the disclosed rotor blade may be incorporated into a compressor section or a turbine section of the gas turbine engine. Specifically, in several embodiments, the rotor blade includes a structural member formed from a metallic material. The structural member, in turn, supports or otherwise absorbs the mechanical loads placed on the rotor blade. In several embodiments, the structural member includes a base portion that at least partially forms a root and a shank of the rotor blade. Furthermore, the structural member includes a spar coupled to and extending outward from the base portion in a radial direction. In addition, the structural member includes a tip cap coupled to the outer radial end of the spar. For example, in one embodiment, the structural member is integrally formed as a single monolithic component.

Moreover, the rotor blade includes a fairing formed from a composite material. In general, the fairing supports or otherwise absorbs the thermal loading placed on the rotor blade. Thus, the use of a composite fairing and a metallic structural member decouples the thermal and mechanical loads placed on the rotor blade. In several embodiments, the fairing is coupled to the structural member such that the fairing forms at least a portion of an airfoil and a platform of the rotor blade. As such, the fairing encloses the spar and is positioned between the base portion and the tip cap in the radial direction. Additionally, the fairing includes first and second fairing panels, with such panels contacting each other at first and second split lines. In some embodiments, the fairing defines a plurality of cooling holes (e.g., film cooling holes) at the split lines.

The use of first and second fairing panels that contact each other at first and second split lines provides one or more technical advantages. More specifically, conventional rotor blade incorporating metallic and composite materials are split at the shank (i.e., have a two-piece shank). However, the shank is one of the most highly loaded portions of the rotor blade. In this respect, splitting the rotor blade at the airfoil as disclosed herein (as opposed to the shank) allows the rotor blade to withstand higher mechanical (e.g., centripetal) loads. Thus, the disclosed rotor blade allows a gas turbine engine to operate at higher rotational speeds than conventional rotor blades.

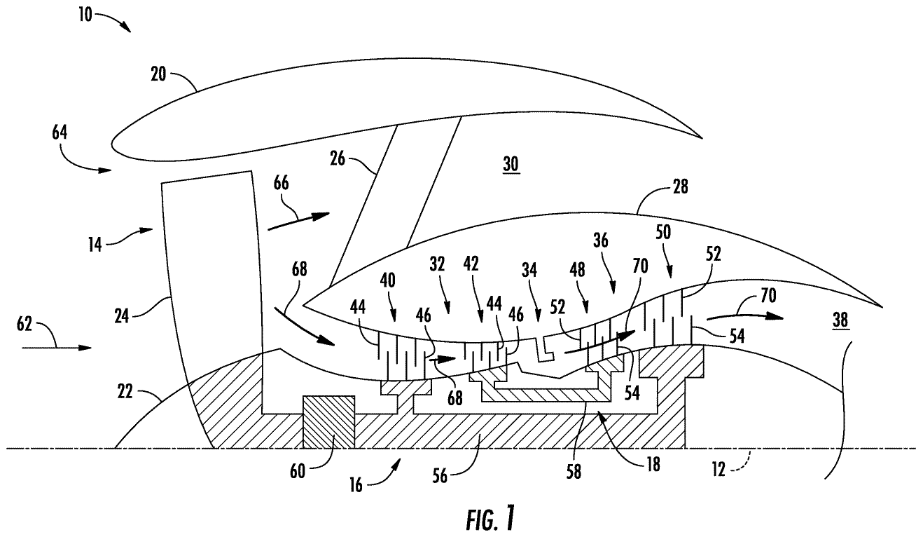

Referring now to the drawings, FIG. 1 is a schematic cross-sectional view of one embodiment of a gas turbine engine 10. In the illustrated embodiment, the engine 10 is configured as a high-bypass turbofan engine. However, in alternative embodiments, the engine 10 may be configured as a propfan engine, a turbojet engine, a turboprop engine, a turboshaft gas turbine engine, or any other suitable type of gas turbine engine.

In general, the engine 10 includes a fan 14, a low-pressure (LP) spool 16, and a high pressure (HP) spool 18 at least partially encased by an annular nacelle 20. More specifically, the fan 14 may include a fan rotor 22 and a plurality of fan blades 24 (one is shown) coupled to the fan rotor 22. In this respect, the fan blades 24 are circumferentially spaced apart from each other and extend outward from the fan rotor 22. Moreover, the LP and HP spools 16, 18 are positioned downstream from the fan 14 along the axial centerline 12. As shown, the LP spool 16 is rotatably coupled to the fan rotor 22, thereby permitting the LP spool 16 to rotate the fan 14. Additionally, a plurality of outlet guide vanes or struts 26 circumferentially spaced apart from each other extend between an outer casing 28 surrounding the LP and HP spools 16, 18 and the nacelle 20. As such, the struts 26 support the nacelle 20 relative to the outer casing 28 such that the outer casing 28 and the nacelle 20 define a bypass airflow passage 30 positioned therebetween.

The outer casing 28 generally surrounds or encases, in serial flow order, a compressor section 32, a combustion section 34, a turbine section 36, and an exhaust section 38. For example, in some embodiments, the compressor section 32 may include a low-pressure (LP) compressor 40 of the LP spool 16 and a high-pressure (HP) compressor 42 of the HP spool 18 positioned downstream from the LP compressor 40 along the axial centerline 12. Each compressor 40, 42 may, in turn, include one or more rows of stator vanes 44 interdigitated with one or more rows of compressor rotor blades 46. Moreover, in some embodiments, the turbine section 36 includes a high-pressure (HP) turbine 48 of the HP spool 18 and a low-pressure (LP) turbine 50 of the LP spool 16 positioned downstream from the HP turbine 48 along the axial centerline 12. Each turbine 48, 50 may, in turn, include one or more rows of stator vanes 52 interdigitated with one or more rows of turbine rotor blades 54.

Additionally, the LP spool 16 includes the low-pressure (LP) shaft 56 and the HP spool 18 includes a high pressure (HP) shaft 58 positioned concentrically around the LP shaft 56. In such embodiments, the HP shaft 58 rotatably couples the rotor blades 54 of the HP turbine 48 and the rotor blades 46 of the HP compressor 42 such that rotation of the HP turbine rotor blades 54 rotatably drives HP compressor rotor blades 46. As shown, the LP shaft 56 is directly coupled to the rotor blades 54 of the LP turbine 50 and the rotor blades 46 of the LP compressor 40. Furthermore, the LP shaft 56 is coupled to the fan 14 via a gearbox 60. In this respect, the rotation of the LP turbine rotor blades 54 rotatably drives the LP compressor rotor blades 46 and the fan blades 24.

In several embodiments, the engine 10 may generate thrust to propel an aircraft. More specifically, during operation, air (indicated by arrow 62) enters an inlet portion 64 of the engine 10. The fan 14 supplies a first portion (indicated by arrow 66) of the air 62 to the bypass airflow passage 30 and a second portion (indicated by arrow 68) of the air 62 to the compressor section 32. The second portion 68 of the air 62 first flows through the LP compressor 40 in which the rotor blades 46 therein progressively compress the second portion 68 of the air 62. Next, the second portion 68 of the air 62 flows through the HP compressor 42 in which the rotor blades 46 therein continue progressively compressing the second portion 68 of the air 62. The compressed second portion 68 of the air 62 is subsequently delivered to the combustion section 34. In the combustion section 34, the second portion 68 of the air 62 mixes with fuel and burns to generate high-temperature and high-pressure combustion gases 70. Thereafter, the combustion gases 70 flow through the HP turbine 48 which the HP turbine rotor blades 54 extract a first portion of kinetic and/or thermal energy therefrom. This energy extraction rotates the HP shaft 58, thereby driving the HP compressor 42. The combustion gases 70 then flow through the LP turbine 50 in which the LP turbine rotor blades 54 extract a second portion of kinetic and/or thermal energy therefrom. This energy extraction rotates the LP shaft 56, thereby driving the LP compressor 40 and the fan 14 via the gearbox 60. The combustion gases 70 then exit the engine 10 through the exhaust section 38.

The configuration of the gas turbine engine 10 described above and shown in FIG. 1 is provided only to place the present subject matter in an exemplary field of use. Thus, the present subject matter may be readily adaptable to any manner of gas turbine engine configuration, including other types of aviation-based gas turbine engines, marine-based gas turbine engines, and/or land-based/industrial gas turbine engines.

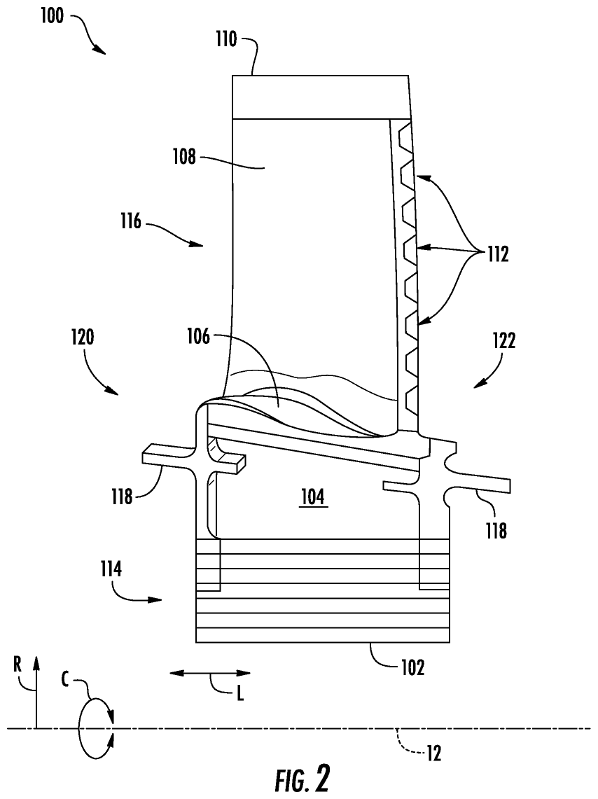

FIG. 2 is a side view of one embodiment of a rotor blade 100, which may be incorporated into the engine 10 in place of any of the compressor rotor blades 40 and/or the turbine rotor blades 48. As shown, the rotor blade 100 defines a longitudinal direction L, a radial direction R, and a circumferential direction C. In this respect, the longitudinal direction L extends parallel to the axial centerline 16 of the engine 10, the radial direction R extends generally orthogonal to the axial centerline 16, and the circumferential direction C extends generally concentrically around the axial centerline 16.

In general, the rotor blade 100 includes a root 102, a shank 104, a platform 106, and an airfoil 108. More specifically, the root 102 couples the rotor blade 100 to a rotor disk (not shown) of one of the LP or HP shafts 56, 58 (FIG. 1). In the illustrated embodiment, the root 102 is configured as a fir-tree type root. However, in alternative embodiments, the root 102 may be configured as a dovetail root or any other suitable structure for coupling the rotor blade 100 to the rotor disk. Additionally, the shank 106 is coupled to and extends outward from the root 102 in the radial direction R. Moreover, the platform 106 is coupled to and extends outward from the shank 104 in the radial direction R. The platform 106 forms the inner radial boundary of the flow path (i.e., for the air 68 or the combustion gases 70) through the corresponding compressor section 32 or turbine section 36. Furthermore, the airfoil 108 is coupled to and extends outward from the platform 106 to a tip cap 110 in the radial direction R. As such, the airfoil 108 is positioned within the flow of the air 68 or the combustion gases 70, thereby imparting energy thereto or extracting energy therefrom. In addition, as will be described below, the airfoil 108 may define one or more cooling holes 112 (e.g., a film cooling hole(s)) for cooling the exterior surface of the airfoil 108.

The various portions of the rotor blade 100 described above are at least partially formed from a structural member 114, a fairing 116, and a pair of side members 118. More specifically, in several embodiments, the root 102 and the shank 104 are formed by the structural member 114 and the side members 118. Moreover, in such embodiments, the platform 106 is formed by the fairing 116 and the side members 118. Additionally, in such embodiments, the airfoil 108 is formed by the fairing 116 and the structural member 114 (i.e., the tip cap 110). However, in alternative embodiments, the various portions of the rotor blade 100 may generally be formed by any combination the structural member 114, the fairing 116, and the side members 118 so long as the majority of the root 102 and the shank 104 are formed by the structural member 114 and the majority of the platform 106 and the airfoil 108 are primarily formed by the fairing 116.

In several embodiments, the side members 118 secure the fairing 116 to the structural member 114. More specifically, the fairing 116 is installed on or otherwise coupled to the structural member 114 such that the fairing 116 is positioned between at least a portion of the side members 118 and the tip cap 110 in the radial direction R. In the illustrated embodiment, one side member 118 is coupled to a forward end 120 (i.e., relative to the flow of the air/combustion gases 68/70) of the rotor blade 100. Moreover, in the illustrated embodiment, a second side member 118 is coupled to an aft end 122 (i.e., relative to the flow of the air/combustion gases 68/70) of the rotor blade 100. As such, the side members 118 prevent the fairing 116 from moving inward (i.e., toward the axial centerline 12 of the engine 10) along the radial direction R relative to the structural member 114. Furthermore, the tip cap 110 prevents the fairing 116 from moving outward (i.e., away the axial centerline 12 of the engine 10) along the radial direction R relative to the structural member 114.

The structural member 114 and the fairing 116 allow the mechanical and thermal loads placed on the rotor blade 100 to be decoupled. More specifically, the root 102 and the shank 104 generally experience the majority of the mechanical (e.g., centripetal) loading placed on the rotor blade 100. Conversely, the platform 106 and the airfoil 108 experience the majority of the thermal loading paced on the rotor blade 100. As mentioned above, metallic materials are typically better suited to withstand mechanical loads than CMC materials, while CMC materials are typically better suited to withstand thermal loads than metallic materials. In this respect, the structural member 114, which forms the majority of the root 102 and the shank 104, is formed from a metallic material (e.g., a nickel-based alloy). Conversely, the fairing 114, which forms the majority of the platform 106 and the airfoil 108, is formed from a composite material, such as a ceramic matrix composite (CMC)). Thus, the portions of the rotor blade 100 experiencing the highest mechanical loading are formed from a material (i.e., a metal) well-suited for such loading, while the portions of the rotor blade 100 experiencing the highest thermal loading are formed from a material (i.e., a composite) well-suited for such loading. Additionally, the side members 118 may be formed from either metallic materials or composite materials.

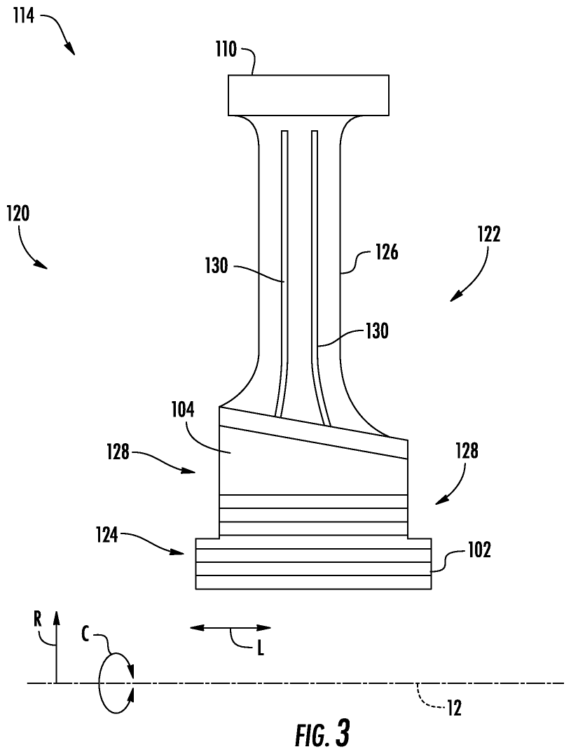

FIG. 3 is a side view of one embodiment of the structural member 114. As shown, the structural member 114 includes a base portion 124, a spar 126, and a tip cap 110. In this respect, the base portion 124 forms portions of the root 102 and the shank 104. Thus, the base portion 124 forms the innermost portion of the structural member 114 in the radial direction R. In some embodiments, the base portion 124 defines a pair of cavities 128 in which the side members 118 (FIG. 2) are at least partially received. Furthermore, the spar 126 is coupled to and extends outward in the radial direction R from the base portion 124 to the tip cap 110. In this respect, the spar 126 extends through the fairing 116, thereby coupling the base portion 124 and the tip cap 110. In one embodiment, one or more ribs 130 extend outward from and run along the radial length of the spar 126. As will be described below, the ribs 130 may partially define cooling passages within the airfoil 108.

Additionally, in several embodiments, the structural member 114 is integrally formed, such as from a single crystal of a nickel-based alloy. Such integral construction increases the mechanical loading that the structural member 114 can withstand. However, in alternative embodiments, the structural member 114 may be formed from multiple components joined (e.g., welded) together.

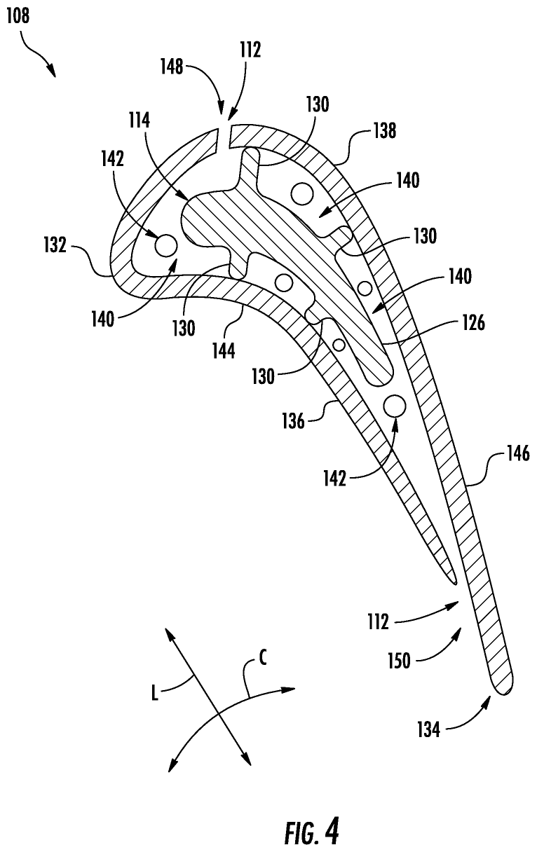

FIG. 4 is a cross-sectional view of the airfoil 108 of the rotor blade 100. As shown, the airfoil 108 extends from a leading edge 132 to a trailing edge 134. In this respect, the airfoil 108 includes a pressure-side surface 136 and a suction-side surface 138 extending between the leading and trailing edges 132, 134 on opposite sides of the airfoil 108. As mentioned above, the airfoil 108 is primarily formed by the fairing 116. In this respect, the fairing 116 primarily forms the pressure- and suction-side surfaces 136, 138.

Moreover, one or more cooling passages 140 may extend through the airfoil 108. More specifically, the fairing 116 encloses or otherwise surrounds the spar 126 of the structural member 114. That is, the fairing 116 is hollow such that the spar 126 can extend through the fairing 116 between the shank 104 (FIG. 3) and the tip cap 110 (FIG. 3). Thus, as shown in FIG. 4, the fairing 116 and the spar 126 are spaced apart from each other (e.g., in the longitudinal and circumferential directions L, C) such that a clearance or cavity is present between the fairing 116 and the spar 126. Furthermore, as mentioned above, in some embodiments, one or more ribs 130 extend outward from and run along the radial length of the spar 126. In such embodiments, the rib(s) 130 contact the fairing 116 such that the clearance/cavity between the fairing 116 and the spar 126 is divided into a plurality of cooling passages 140. Such cooling passages 140 may be fed with coolant received from passages 142 extending through the root 102 and the shank 104. In this respect, each cooling passage 140 may be sized to create the desired flow speed of coolant therethrough. However, in alternative embodiments, the structural member 114 may not include any ribs 130 such that the clearance/cavity forms a single cooling passage. In a further embodiment without ribs 130, the clearance/cavity may not form a cooling passage(s). Instead, in such an embodiment, the clearance/cavity may be filled with stagnant air. Additionally, as shown, in one embodiment, the spar 126 has a solid cross-section.

The fairing 116 is formed from a first fairing panel 144 and a second fairing panel 146. In general, the use of the first and second fairing panels 144, 146 allows installation of the fairing 116 on the structural member 114, such as when the structural member 114 is integrally formed. More specifically, as shown, the first and second panels 144, 146 contact or abut each other at first and second split lines or seams 148, 150. For example, in the illustrated embodiment, the first split line 148 is located on the suction-side surface 138 between the leading and trailing edge 132, 134. Furthermore, in the illustrated embodiment, the second split line 150 is located at or adjacent to the trailing edge 134. In this respect, the first fairing panel 144 forms the pressure-side surface 136 and a forward portion of the suction-side surface 138. Conversely, the second fairing panel 146 forms an aft portion of the suction-side surface 138. As will be described below, cooling holes 112 (e.g., film cooling holes) may be formed at the split lines 148, 150. However, in alternative embodiments, the split lines 148, 150 may be located at any other suitable locations on the airfoil 108. Moreover, in further embodiments, the fairing 114 may include three or more panels.

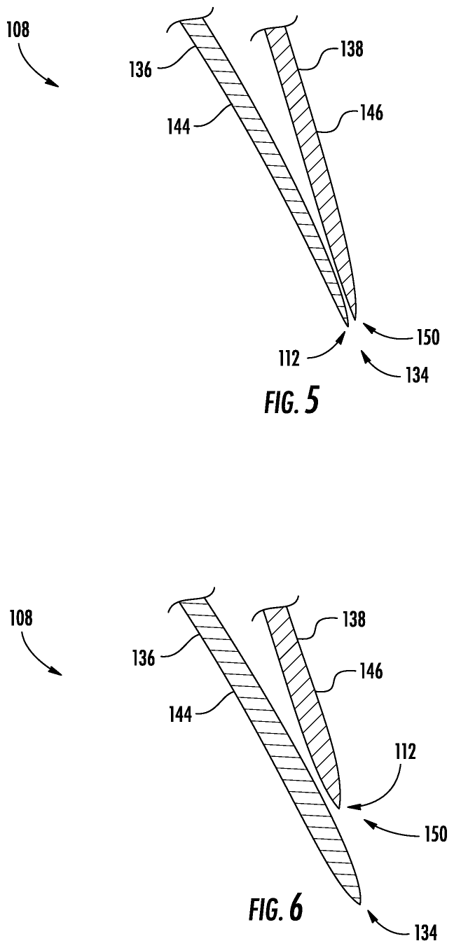

As mentioned above, the second split line 150 may be positioned adjacent to the trailing edge 132 of the airfoil 108. For example, as shown in FIG. 4, in one embodiment, the second split line 150 is positioned on the pressure-side surface 136 of the airfoil 108 adjacent to the trailing edge 132. Moreover, as shown in FIG. 5, in another embodiment, the second split line 150 is positioned at the trailing edge 132. Furthermore, as shown in FIG. 6, in a further embodiment, the second split line 150 is positioned on the suction-side surface 138 of the airfoil 108 adjacent to the trailing edge 132. However, in alternative embodiments, the second split line 150 may be positioned at any other suitable position.

The use of the first and second fairing panels 144, 146 that contact/abut each other at the first and second split lines 148, 150 provides one or more technical advantages. More specifically, conventional rotor blades incorporating metallic and composite materials are split at the shank (i.e., have a two-piece shank). However, the shank is one of the most highly loaded portions of the rotor blade. In this respect, splitting the rotor blade 100 at the airfoil 108 as opposed to the shank 104 (the shank 104 is almost entirely a single piece except for the portions formed by the side members 118) allows the rotor blade 100 to withstand higher mechanical (e.g., centripetal) loads. Thus, the disclosed rotor blade 100 allows a gas turbine engine 10 to operate at higher rotational speeds than conventional rotor blades.

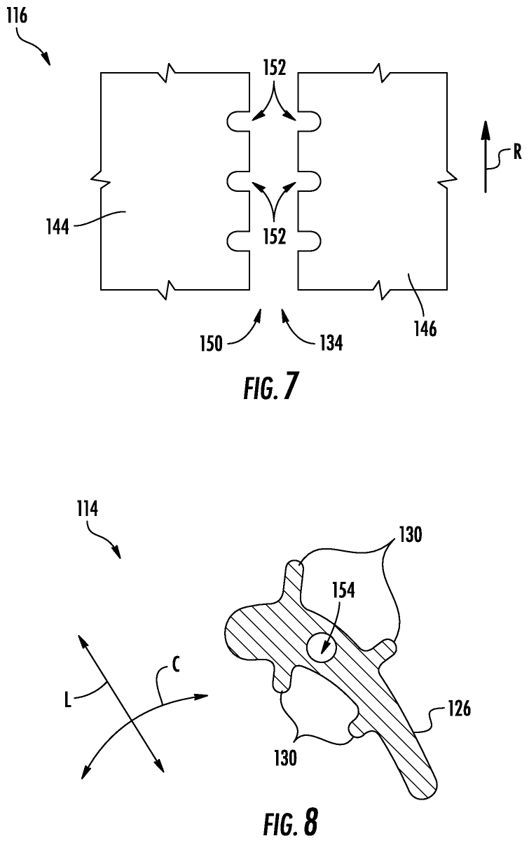

FIG. 7 is a partial rear view of one embodiment of the airfoil 108. Specifically, FIG. 7 illustrates a portion of the trailing edge 134 of the airfoil 108, with the first and second fairing panels 144, 146 spaced apart at the second split line 150 for clarity. As shown, the first and second fairing panels 144, 146 define a plurality of notches 152 at the second split line 150. As such, when the first and second fairing panels 144, 146 are in contact with each other, the notches 152 form cooling holes 112 (FIGS. 2 and 4) at the second split line 150. Although the embodiment shown in FIG. 7 includes notches 152 formed in both of the first and second fairing panels 144, 146, the notches 152 may only be formed in one of the first and second fairing panels 144, 146. Additionally, the first and/or second fairing panels 144, 146 may define a plurality of notches 152 at the first split line 148 such that the cooling holes 112 are similarly formed at the first split line 148. While it is generally desirable to form cooling holes 112 at the first and second split lines 148, 150 as these seams/joints are difficult to seal, in some embodiments, no cooling holes may be present at the split lines 148, 150.

The cooling holes 112 may have any suitable shapes and/or geometries. For example, the cooling holes 112 may be circular holes, elliptical holes, elongated slots, trenches, and/or the like.

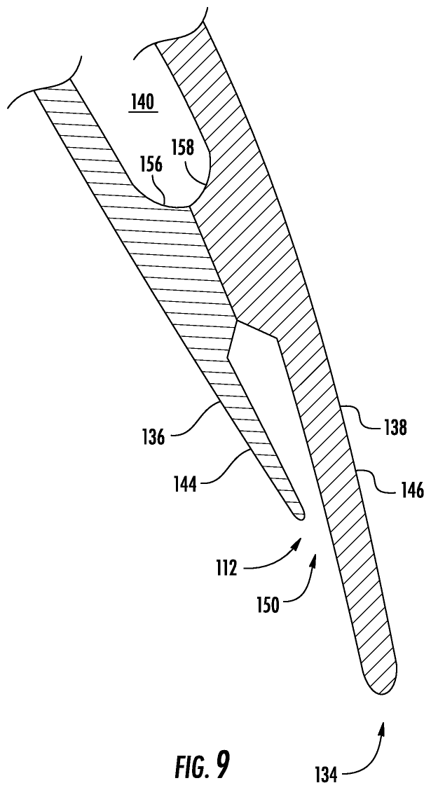

FIG. 8 is cross-sectional view of another embodiment of a structural member 114. Like the embodiment of the structural member 114 shown in FIG. 4, the structural member 114 shown in FIG. 8 includes a spar 126. However, unlike the embodiment of the structural member 114 shown in FIG. 4, the spar 126 shown in FIG. 8 defines a cooling passage 154 extending therethrough. The cooling passage 154 may, in turn, provide coolant to the tip cap 110 (FIGS. 2 and 3) for cooling the tip cap 110. Such cooling of the tip cap 110 may be in addition to or in lieu of any tip cap cooling provided by the cooling passages 140 (FIG. 4). Although FIG. 8 only illustrates one cooling passage 154, any other suitable number of cooling passages 154 may extend through the spar 126 to provide coolant to the tip cap 110.

As indicated above, in several embodiments, the first and second fairing panels 144, 146 contact each other at the first and second split lines 148, 150. However, in other embodiments, the panels 144, 146 may contact each other at other locations. For example, as shown in FIG. 9, the first fairing panel 144 includes a first projection 156 extending outward from its interior surface. Similarly, as shown, the second fairing panel 146 includes a second projection 158 extending outward from its interior surface. In such an embodiment, when the first and second fairing panels 144, 146 are joined, the first and second projections 156, 158 contact each other, thereby forming the airfoil 108. In some embodiments, the first and second projections 156, 158 may interlock with each other. Additionally, in the illustrated embodiment, the first and second projections 156, 158 are positioned adjacent to the trailing edge 150. However, in alternative embodiments, the first and second projections 156, 158 may be positioned at any other suitable locations and/or the first and second fairing panels 144, 146 may contact each other in any other suitable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A rotor blade for a gas turbine engine, the rotor blade comprising: a structural member formed from a metallic material, the structural member including a base portion, a spar, and a tip cap, the base portion at least partially forming a root of the rotor blade and a shank of the rotor blade; and a fairing formed from a composite material, the fairing coupled to the structural member such that the fairing forms at least a portion of an airfoil of the rotor blade and a platform of the rotor blade, the fairing including a first fairing panel and a second fairing panel in contact with the first fairing panel at a first split line and a second split line.

The rotor blade of one or more of these clauses, wherein the fairing encloses at least a portion of the spar.

The rotor blade of one or more of these clauses, wherein the fairing defines a plurality of cooling holes located at the first split line or the second split line.

The rotor blade of one or more of these clauses, wherein at least one of the first fairing panel or the second fairing panel defines a plurality of notches such that, when the first fairing panel is in contact with the second fairing panel at the first and second split lines, each of the plurality of notches partially defines one of the plurality of cooling holes.

The rotor blade of one or more of these clauses, wherein the first split line is located on a suction side of the airfoil between a leading edge of the airfoil and a trailing edge of the airfoil.

The rotor blade of one or more of these clauses, wherein the second split line is located adjacent to a trailing edge of the airfoil.

The rotor blade of one or more of these clauses, further comprising: first and second side members coupling the fairing to the base portion of the structural member.

The rotor blade of one or more of these clauses, wherein the first side member and the second side member partially form the root of the rotor blade.

The rotor blade of one or more of these clauses, wherein the structural member includes a plurality of ribs extending outward from the spar such that the plurality of ribs contacts the fairing.

The rotor blade of one or more of these clauses, wherein the spar, the fairing, and the plurality of ribs define one or more cooling channels.

The rotor blade of one or more of these clauses, wherein the structural member is integrally formed.

The rotor blade of one or more of these clauses, wherein the tip cap applies a compressive load on the fairing.

The rotor blade of one or more of these clauses, wherein the spar defines a cooling passage configured to direct coolant to the tip cap.

The rotor blade of one or more of these clauses, wherein the spar is solid.

A gas turbine engine, comprising: a compressor section; a combustion section; a turbine section; and a rotor blade positioned within the turbine section, the rotor blade comprising: a structural member formed from a metallic material, the structural member including a base portion, a spar, and a tip cap, the base portion at least partially forming a root of the rotor blade and a shank of the rotor blade; and a fairing formed from a composite material, the fairing coupled to the structural member such that the fairing forms at least a portion of an airfoil of the rotor blade and a platform of the rotor blade, the fairing including a first fairing panel and a second fairing panel in contact with the first fairing panel at a first split line and a second split line.

The gas turbine engine of one or more of these clauses, wherein the fairing encloses at least a portion of the spar.

The gas turbine engine of one or more of these clauses, wherein the fairing defines a plurality of cooling holes located at the first split line or the second split line.

The gas turbine engine of one or more of these clauses, wherein at least one of the first fairing panel or the second fairing panel defines a plurality of notches such that, when the first fairing panel is in contact with the second fairing panel at the first and second split lines, each of the plurality of notches partially defines one of the plurality of cooling holes.

The gas turbine engine of one or more of these clauses, wherein the first split line is located on a suction side of the airfoil between a leading edge of the airfoil and a trailing edge of the airfoil and the second split line is located adjacent to the trailing edge.

A rotor blade for a gas turbine engine, the rotor blade comprising: a structural member formed from a metallic material, the structural member including a base portion, a spar, and a tip cap, the base portion at least partially forming a root of the rotor blade and a shank of the rotor blade; and a fairing formed from a composite material, the fairing coupled to the structural member such that the fairing forms at least a portion of an airfoil of the rotor blade and a platform of the rotor blade, the fairing including a first fairing panel having a first projection and a second fairing panel having a second projection in contact with the first projection.

What is claimed is:

1. A rotor blade for a gas turbine engine, the rotor blade comprising:
a structural member formed from a metallic material, the structural member including a base portion, a spar, and a tip cap, the base portion at least partially forming a root of the rotor blade and a shank of the rotor blade; and
a fairing formed from a composite material, the fairing coupled to the structural member such that the fairing forms at least a portion of an airfoil of the rotor blade and a platform of the rotor blade, the fairing including a first fairing panel and a second fairing panel in contact with the first fairing panel at a first split line and a second split line.

2. The rotor blade of claim 1, wherein the fairing encloses at least a portion of the spar.

3. The rotor blade of claim 1, wherein the fairing defines a plurality of cooling holes located at the first split line or the second split line.

4. The rotor blade of claim 3, wherein at least one of the first fairing panel or the second fairing panel defines a plurality of notches such that, when the first fairing panel is in contact with the second fairing panel at the first and second split lines, each of the plurality of notches partially defines one of the plurality of cooling holes.

5. The rotor blade of claim 1, wherein the first split line is located on a suction side of the airfoil between a leading edge of the airfoil and a trailing edge of the airfoil.

6. The rotor blade of claim 5, wherein the second split line is located adjacent to a trailing edge of the airfoil.

7. The rotor blade of claim 1, further comprising:
first and second side members coupling the fairing to the base portion of the structural member.

8. The rotor blade of claim 7, wherein the first side member and the second side member partially form the root of the rotor blade.

9. The rotor blade of claim 1, wherein the structural member includes a plurality of ribs extending outward from the spar such that the plurality of ribs contacts the fairing.

10. The rotor blade of claim 9, wherein the spar, the fairing, and the plurality of ribs define one or more cooling channels.

11. The rotor blade of claim 1, wherein the structural member is integrally formed.

12. The rotor blade of claim 1, wherein the tip cap applies a compressive load on the fairing.

13. The rotor blade of claim 1, wherein the spar defines a cooling passage configured to direct coolant to the tip cap.

14. The rotor blade of claim 1, wherein the spar is solid.

15. A gas turbine engine, comprising:
a compressor section;
a combustion section;
a turbine section; and
a rotor blade positioned within the turbine section, the rotor blade comprising:
a structural member formed from a metallic material, the structural member including a base portion, a spar, and a tip cap, the base portion at least partially forming a root of the rotor blade and a shank of the rotor blade; and
a fairing formed from a composite material, the fairing coupled to the structural member such that the fairing forms at least a portion of an airfoil of the rotor blade and a platform of the rotor blade, the fairing including a first fairing panel and a second fairing panel in contact with the first fairing panel at a first split line and a second split line.

16. The gas turbine engine of claim 15, wherein the fairing encloses at least a portion of the spar.

17. The gas turbine engine of claim 15, wherein the fairing defines a plurality of cooling holes located at the first split line or the second split line.

18. The gas turbine engine of claim 17, wherein at least one of the first fairing panel or the second fairing panel defines a plurality of notches such that, when the first fairing panel is in contact with the second fairing panel at the first and second split lines, each of the plurality of notches partially defines one of the plurality of cooling holes.

19. The gas turbine engine of claim 15, wherein the first split line is located on a suction side of the airfoil between a leading edge of the airfoil and a trailing edge of the airfoil and the second split line is located adjacent to the trailing edge.

20. A rotor blade for a gas turbine engine, the rotor blade comprising:
a structural member formed from a metallic material, the structural member including a base portion, a spar, and a tip cap, the base portion at least partially forming a root of the rotor blade and a shank of the rotor blade; and
a fairing formed from a composite material, the fairing coupled to the structural member such that the fairing forms at least a portion of an airfoil of the rotor blade and a platform of the rotor blade, the fairing including a first fairing panel having a first projection and a second fairing panel having a second projection in contact with the first projection.
